(19) United States
(12) Patent Application Publication
(10) Pub. No.: US 2025/0308076 A1
(43) Pub. Date: Oct. 2, 2025

(54) EFFICIENT DETECTION OF BOUNDARY LOOPS IN POLYGON MESHES

(71) Applicant: Tencent America LLC, Palo Alto, CA (US)

(72) Inventors: Chao HUANG, Palo Alto, PA (US); Shan LIU, San Jose, CA (US)

(73) Assignee: Tencent America LLC, Palo Alto, CA (US)

(21) Appl. No.: 19/047,580

(22) Filed: Feb. 6, 2025

Related U.S. Application Data
(60) Provisional application No. 63/570,216, filed on Mar. 26, 2024.

(51) Int. Cl. G06T 9/00; G06T 17/20

(52) U.S. Cl. CPC G06T 9/001; G06T 17/20

(57) ABSTRACT

A bitstream of a mesh that includes a plurality of vertices is received. A previous vertex set including one or more previous vertices of a current vertex of the mesh and a next vertex set including one or more next vertices of the current vertex of the mesh are determined. Each of the one or more previous vertices and the one or more next vertices of the current vertex corresponds to a respective index. Whether the current vertex is a boundary vertex in a boundary loop of the mesh is determined based on whether a first result of an exclusive or (XOR) operation performed on the indices of the one or more previous vertices and the one or more next vertices is zero. The boundary loop of the mesh is generated based on the current vertex when the first result of the XOR operation is not zero.

### INCORPORATION BY REFERENCE

The present application claims the benefit of priority to U.S. Provisional Application No. 63/570,216, “EFFICIENT DETECTION OF BOUNDARY LOOPS IN POLYGON MESHES” filed on Mar. 26, 2024, which is incorporated by reference herein in its entirety.

### TECHNICAL FIELD

The present disclosure describes aspects generally related to mesh coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include bitstreams, methods, and apparatuses for mesh processing. In some examples, an apparatus for mesh processing includes processing circuitry.

According to an aspect of the disclosure, a method of mesh decoding is provided. In the method, a bitstream of a mesh that includes a plurality of vertices is received. A previous vertex set including one or more previous vertices of a current vertex of the mesh and a next vertex set including one or more next vertices of the current vertex of the mesh are determined. Each of the one or more previous vertices and the one or more next vertices of the current vertex corresponds to a respective index. Whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero. The boundary loop of the mesh is generated based on the current vertex when the first result of the XOR operation is not zero.

According to another aspect of the disclosure, a method of mesh encoding is provided. In the method, a previous vertex set including one or more previous vertices of a current vertex of a mesh and a next vertex set including one or more next vertices of the current vertex of the mesh are determined. Each of the one or more previous vertices and the one or more next vertices of the current vertex corresponds to a respective index. Whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero. When the current vertex is determined as the boundary vertex in the boundary loop of the mesh, a previous boundary loop vertex and a next boundary loop vertex of the current vertex in the boundary loop are identified. The boundary loop of the mesh is encoded based on (i) the current vertex and (ii) one of the previous boundary loop vertex and the next boundary loop vertex of the current vertex.

According to yet another aspect of the disclosure, a method of processing mesh data is provided. In the method, a bitstream of the mesh data is processed according to a format rule. The bitstream includes coded information of a mesh with a plurality of vertices. The format rule specifies that a previous vertex set including one or more previous vertices of a current vertex of the mesh and a next vertex set including one or more next vertices of the current vertex of the mesh are determined. Each of the one or more previous vertices and the one or more next vertices of the current vertex corresponds to a respective index. The format rule specifies that whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero. The format rule specifies that the boundary loop of the mesh is processed based on the current vertex when the first result of the XOR operation is not zero.

Aspects of the disclosure also provide an apparatus for mesh encoding. The apparatus for mesh encoding including processing circuitry configured to implement any of the described methods for mesh encoding.

Aspects of the disclosure also provide an apparatus for mesh decoding. The apparatus for mesh decoding including processing circuitry configured to implement any of the described methods for mesh decoding.

Aspects of the disclosure also provide a non-transitory computer-readable medium storing instructions which, when executed by a computer, cause the computer to perform any of the described methods for mesh decoding, encoding, and mesh data processing.

Technical solutions of the disclosure include methods and apparatuses for improving coding efficiency of coding boundary loops in a polygon mesh by applying an exclusive OR operation on indices of vertices of the polygon mesh. In an example, a bitstream of a mesh that includes a plurality of vertices is received. A previous vertex set including one or more previous vertices of a current vertex of the mesh and a next vertex set including one or more next vertices of the current vertex of the mesh are determined. Each of the one or more previous vertices and the one or more next vertices of the current vertex corresponds to a respective index. Whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero. The boundary loop of the mesh is generated based on the current vertex when the first result of the XOR operation is not zero. Thus, by applying exclusive OR operation on the indices of the vertices in the polygon mesh to determine the boundary loops of the mesh, coding efficiency can be improved.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of an example of a boundary loop in a mesh according to an aspect of the disclosure.

FIG. 5 is a schematic illustration of an example of a plurality of vertices in a mesh according to an aspect of the disclosure.

FIG. 6 shows a flow chart outlining a mesh decoding process according to some aspects of the disclosure.

FIG. 7 shows a flow chart outlining a mesh encoding process according to some aspects of the disclosure.

FIG. 8 is a schematic illustration of a computer system in accordance with an aspect of the disclosure.

### DETAILED DESCRIPTION

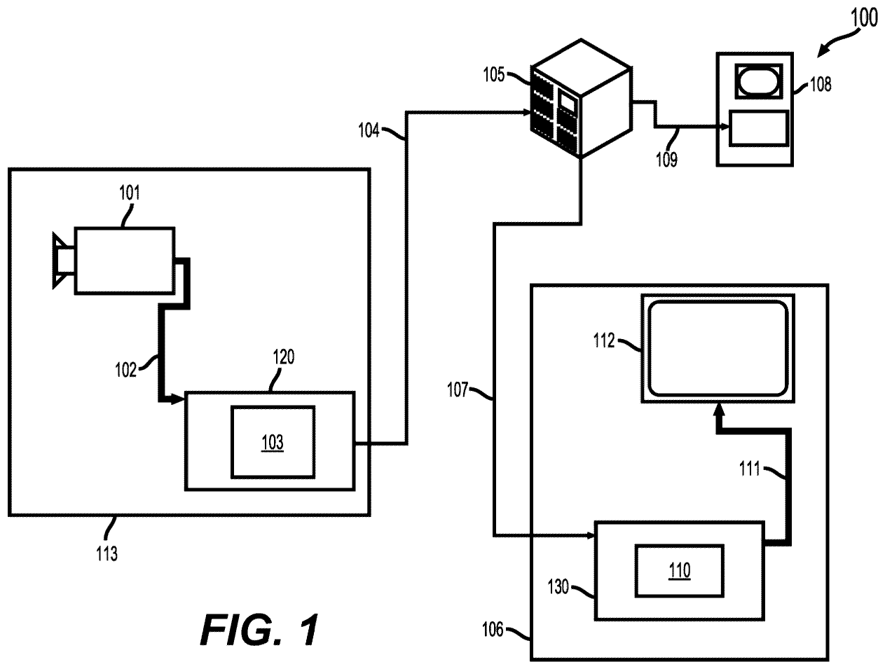

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101). The video source (101) may include one or more images captured by a camera and/or generated by a computer. For example, a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

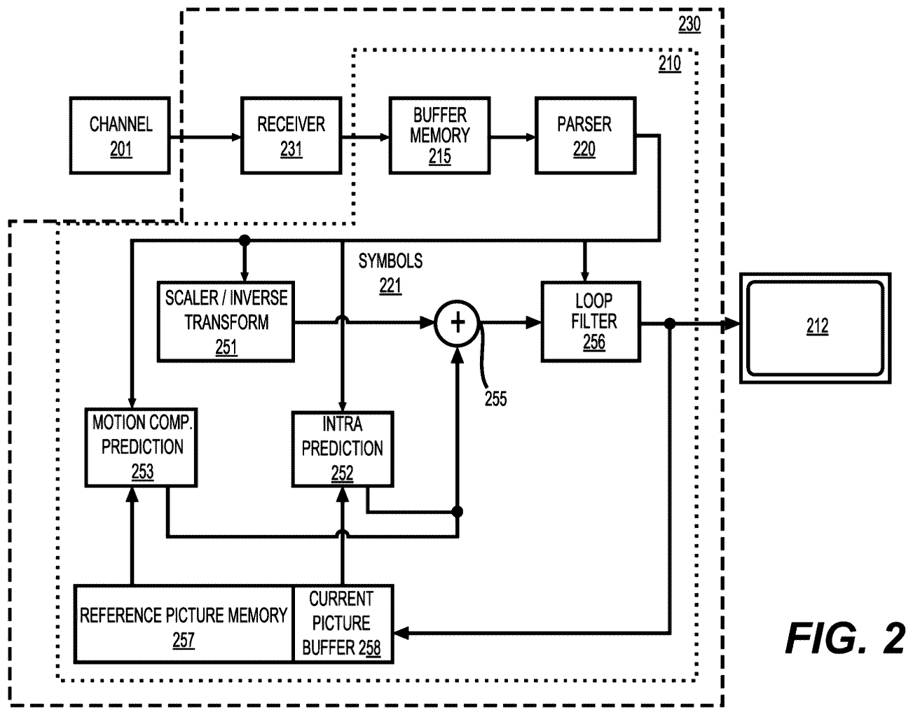

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

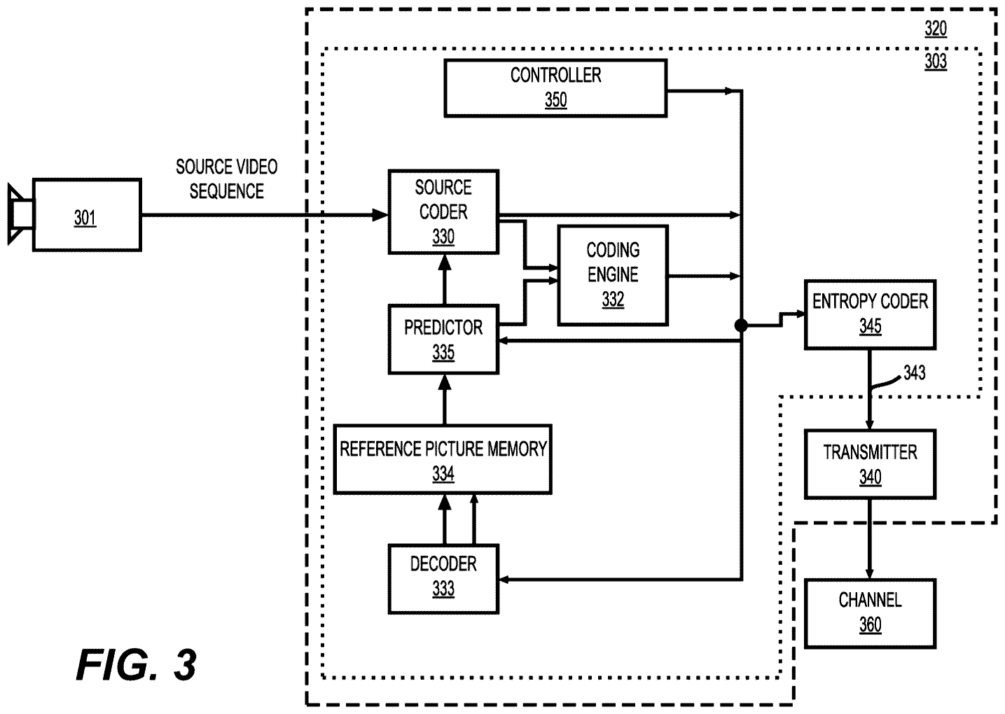

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture (or a mesh) to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure include methods and systems directed to an algorithm to more efficiently detect boundary loops in polygon meshes.

Meshes are widely used to represent immersive contents, which may require a large amount of data. For example, dynamic mesh sequences include a significant amount of information changing over time. Therefore, efficient compression technologies are required to store and transmit such contents. Mesh compression standards, such as IC, MESHGRID, frame-based animated mesh compression (FAMC), were previously developed by MPEG to address dynamic meshes with constant connectivity, time varying geometry, and vertex attributes. However, these standards may not consider time varying attribute maps and connectivity information. Although DCC (digital content creation) tools may generate such dynamic meshes, it is challenging for volumetric acquisition techniques to generate a constant connectivity dynamic mesh, such as under real time constraints. Contents in the constant connectivity dynamic mesh may not be supported by the existing standards.

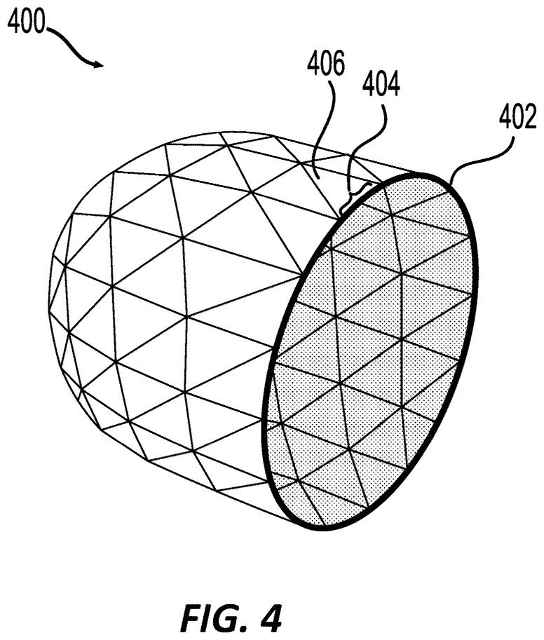

Boundary loop detection has many applications in mesh processing, such as remeshing, mesh compression, mesh deformation, and mesh registration etc. For example, the boundary loop detection may be used to add dummy faces to form a closed surface in mesh compression. A boundary loop may include boundary edges such that each of the boundary edge has only one incident face. An example of the boundary loop is shown in FIG. 4. As shown in FIG. 4, a three-dimensional (3D) mesh (400) includes a boundary loop (402). The boundary loop (402) includes a plurality of boundary edges, such as a boundary edge (404). Each of the boundary edges of the boundary loop (402) has a respective incident face. For example, the boundary edge (404) has an incident face (406).

Boundary loop detection has various applications in polygon mesh processing and compression. Thus, it is desirable to develop an efficient algorithm to detect boundary loops in polygon meshes.

In the disclosure, an efficient algorithm is provided to detect boundary loops in polygon meshes, such as in a polygon mesh with 2-manifolds. A 2-manifold, also known as a surface, is a topological space that locally resembles a plane. For every point on the surface, a neighborhood may exist that may be mapped to a region of the plane. In an aspect, without loss of generality, an orientation of faces in a mesh may be predefined, such as counter-clockwise.

In an aspect, for each vertex, such as a current vertex, in a mesh, previous vertices and next vertices of the vertex in associated incident faces are identified. The previous vertices and the next vertices for the current vertex may be defined in a pre-defined direction, such as in a counter-clockwise direction. In an example, faces in the mesh are looped through (or traversed). For each face in the mesh, incident vertices of the face are looped through (or traversed). Incident vertices of a face may be vertices that define boundaries of the face in a mesh. In other words, incident vertices are corner points of the mesh that represent the face. Further, for each incident vertex in the face, an index is assigned. A previous vertices set (or previous vertex set) and a next vertices set (or next vertex set) is created for the current vertex in the face. The previous vertices set includes the previous vertices of the current vertex with the previous vertex indices. The next vertices set includes the next vertices of the current vertex with the next vertex indices.

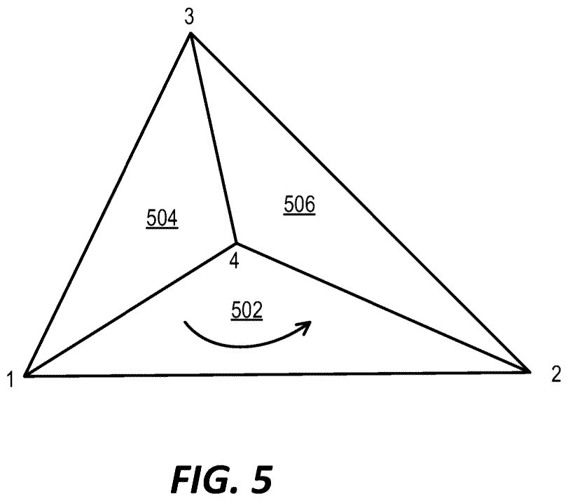

An example of a previous vertices set and a next vertices set for a current vertex is shown in FIG. 5. As shown in FIG. 5, three faces (502), (504), and (506) of a mesh are provided. The face (502) includes a vertex V1 with an index 1, a vertex V2 with an index 2, and a vertex V4 with an index 4. The face (504) includes the vertex V1 with the index 1, the vertex V4 with the index 4, and a vertex V3 with an index 3. The face (506) includes the vertex V2 with the index 2, the vertex V4 with the index 4, and the vertex V2 with the index 2. In an example of FIG. 5, a counter-wise direction is applied to loop through (or traverse) the vertices in each face. Thus, the vertex V1 has previous vertices V3 and V4, and next vertices V2 and V4. The vertex V4 has previous vertices V2, V3 and V1, and next vertices V1, V2, and V3. According to the indices of the vertices, the vertex V1 has a previous vertex set {3, 4} and a next vertex set {2, 4}. The vertex V4 has a previous vertex set {2, 3, 1}, and a next vertex set {1, 2, 3}.

After all the previous vertices and next vertices for each vertex (e.g., vertex V1) in the corresponding incident faces (e.g., face (502) and face (504)) are identified, whether a vertex, such as a current vertex, is a boundary vertex (e.g., incident to a boundary edge) or an internal vertex (e.g., not incident to a boundary edge) may be determined based on the previous vertices and the next vertices. In an aspect, an “exclusive or” operation (XOR) is applied to all indices in a previous vertices set and all indices in a next vertices set of the current vertex. If a result of the XOR is zero, then the current vertex is an internal one. Otherwise, if the result of the XOR is non-zero, the current vertex is a boundary vertex. For example, the XOR operation is applied to the previous vertex set {3, 4} and the next vertex set {2, 4} of the vertex V1. A first result of the XOR operation (or first XOR result) is {2, 3}, which is not zero. Thus, the vertex V1 is a boundary vertex. The XOR operation is applied to the previous vertex set {2, 3, 1} and the next vertex set {1, 2, 3} of the vertex V4. A first result of the XOR operation is {0}. Thus, the vertex V4 is an internal vertex in the mesh.

When a vertex, such as the vertex V1, has been determined as a boundary vertex, a previous vertex (or previous boundary loop vertex) and a next vertex (or next boundary loop vertex) of the boundary vertex in a corresponding boundary loop are defined. Since the first XOR result (e.g., {2, 3}) of the boundary vertex is non-zero, a bit that is equal to one (or 1-bit) in the first XOR result is identified. The 1-bit may be identified as either a least significant 1-bit (e.g., one is a rightmost bit in a binary number) or a most significant 1-bit (e.g., one is a leftmost bit in the binary number) in the first XOR result. In an example, the first XOR result of the vertex V1 is {2, 3}. 2 has a binary representation of 10. 3 has a binary representation of 11. The XOR operation may further be applied to the binary representation 10 of the index 2 and the binary representation 11 of the index 3, a XOR result of 01 is obtained. Thus, the 1-bit is positioned at a least significant location (e.g., the bit at the least significant location is 1) of the binary representation 01 and is a least significant 1-bit.

Further, the indices in the previous vertices set and the next vertices set of the boundary vertex (e.g., vertex V1) that have a 1-bit at a same location (e.g., at the least significant location) as the first XOR result are identified. For example, the identified indices have a least significant 1-bit that is same as the first XOR result. The XOR operation is applied on all the indices that has the 1-bit at the same location as the first XOR result.

In an example, as shown above for the vertex V1, the 1-bit is defined as the least significant 1-bit according to the first XOR result. Indices in the previous vertices set and the next vertices set of the boundary vertex (e.g., vertex V1) are divided into a first group and a second group. For example, for a boundary vertex that includes previous vertices and next vertices with indices of {a, a, b, b, c, c, x, y}, the first group may include indices {a, a, c, c, x} that have a same 1-bit at the same location as the first XOR result. For example, the indices of the first group have a least significant 1-bit as same as the first XOR result. The second group may include indices {b, b, y} that do not have a 1-bit at the same location as the first XOR result. For example, the indices of the second group have a 0-bit at the least significant location (e.g., the bit at the least significant location is 0) or has a least significant 0-bit.

The XOR operation may be applied to the indices of the first group to obtain a second XOR result. According to the XOR operation, identical indices are canceled, and any unique indices remains. For example, after the XOR operation, {x} remains in the second XOR result.

In an aspect, if a vertex indicated by the second XOR result (e.g., {x}) is in the previous vertex set of the boundary vertex, the vertex is defined as the next vertex (or next boundary loop vertex) of the boundary vertex. If the vertex indicated by the second XOR result (e.g., {x}) is in the next vertices set of the boundary vertex, the vertex is defined as the previous vertex (or previous boundary loop vertex) of the boundary vertex.

The XOR operation is then applied on the first XOR result and the second XOR result to obtain the previous vertex of the boundary vertex if the next vertex is identified. Similarly, the XOR operation is applied on the first XOR result and the second XOR result to obtain the next vertex (or next boundary loop vertex) of the boundary vertex if the previous vertex (or previous boundary loop vertex) is identified.

For example, for the boundary vertex that includes the next vertices and the previous vertices with indices of {a, a, b, b, c, c, x, y}, the first XOR result is {x, y} and the second XOR result is {x}. According to the XOR operation on the first XOR result and the second XOR result, {y} remains. The vertex indicated by the index {y} is identified as the previous vertex (or previous boundary loop vertex) of the boundary vertex if the next vertex (or next boundary loop vertex) {x} has been identified in the second XOR result.

A boundary loop corresponding to a boundary vertex may be detected after a next vertex (or next boundary loop vertex) in the boundary loop is determined for the boundary vertex. In an example, each vertex of the mesh is looped through (or traversed). For a vertex, the vertex is skipped if the vertex is an internal vertex or the vertex has been visited. Otherwise, a boundary loop is defined when the vertex is a boundary vertex and has not been visited. The vertex may be defined as a starting vertex of the boundary loop, and other vertices in the boundary loop are determined by identifying subsequent next vertices or previous vertices. For example, a second vertex of the boundary loop is identified as a next boundary loop vertex of the starting vertex. A third vertex of the boundary loop is identified as a next boundary loop vertex of the second vertex of the boundary loop. A last vertex of the boundary loop is such that the starting vertex is a next boundary loop vertex of the last vertex of the boundary loop. The vertices in the boundary loop are also marked as visited so that the vertices are not visited again.

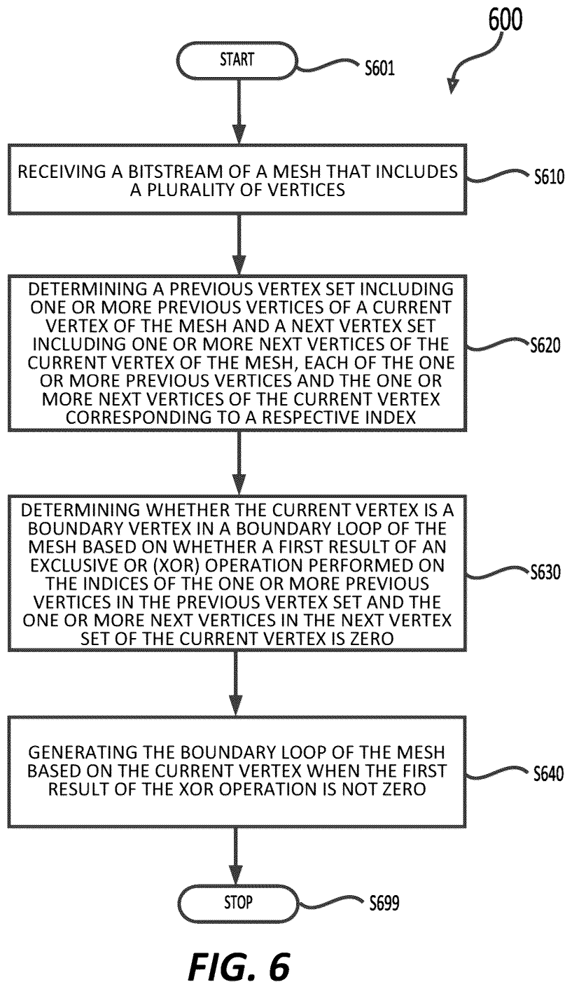

FIG. 6 shows a flow chart outlining a process (600) according to an aspect of the disclosure. The process (600) can be used in a video decoder. In various aspects, the process (600) is executed by processing circuitry, such as the processing circuitry that performs functions of the video decoder (110), the processing circuitry that performs functions of the video decoder (210), and the like. In some aspects, the process (600) is implemented in software instructions, thus when the processing circuitry executes the software instructions, the processing circuitry performs the process (600). The process starts at (S601) and proceeds to (S610).

At (S610), a bitstream of a mesh that includes a plurality of vertices is received.

At (S620), a previous vertex set including one or more previous vertices of a current vertex of the mesh and a next vertex set including one or more next vertices of the current vertex of the mesh are determined. Each of the one or more previous vertices and the one or more next vertices of the current vertex corresponds to a respective index.

At (S630), whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero.

At (S640), the boundary loop of the mesh is generated based on the current vertex when the first result of the XOR operation is not zero.

In an aspect, when the current vertex is determined as the boundary vertex in the boundary loop of the mesh, a previous boundary loop vertex and a next boundary loop vertex of the current vertex in the boundary loop are identified. The boundary loop of the mesh is generated based on (i) the current vertex and (ii) one of the previous boundary loop vertex and the next boundary loop vertex of the current vertex in the boundary loop.

In an aspect, the one or more previous vertices and the one or more next vertices of the current vertex are determined from one or more incident faces of the current vertex according to a predefined traversal direction. Each of the one or more incident faces of the current vertex includes at least one previous vertex and at least one next vertex of the current vertex.

In an aspect, the XOR operation is performed on the indices of the one or more previous vertices and the one or more next vertices of the current vertex to cancel duplicated vertices that have same indices. When the first result of the XOR operation is zero, the current vertex is determined as a non-boundary vertex. When the first result of the XOR operation is non-zero, the current vertex is determined as the boundary vertex in the boundary loop.

In an aspect, a non-zero first result indicates that at least two unique indices exist in the indices of the one or more previous vertices and the one or more next vertices of the current vertex. A significant bit is determined based on the first result of the XOR operation on the indices of the one or more previous vertices and the one or more next vertices of the current vertex. The one or more previous vertices and the one or more next vertices of the current vertex are divided into a first group of neighboring vertices with the significant bit and a second group of neighboring vertices without the significant bit. The XOR operation is performed on the first group of neighboring vertices of the current vertex to obtain a second result. The second result indicates a unique vertex in the first group of neighboring vertices. Whether the unique vertex is the next boundary loop vertex of the current vertex in the boundary loop is determined.

In an aspect, the XOR operation is performed on binary representations of the at least two unique indices to obtain a combined binary representation of the at least two unique indices. The significant bit is determined as one of a least significant bit and a most significant bit of the combined binary representation of the at least two unique indices.

In an aspect, when the unique vertex is included in the previous vertex set, the unique vertex is determined as the next boundary loop vertex of the current vertex in the boundary loop.

In an aspect, when the unique vertex is included in the next vertex set, the unique vertex is determined as the previous boundary loop vertex of the current vertex in the boundary loop.

In an aspect, the XOR operation is performed on the first result and the second result to identify a unique vertex in the first result and the second result as the previous boundary loop vertex of the current vertex in the boundary loop.

In an aspect, a starting vertex of the boundary loop is identified as the current vertex. A second vertex of the boundary loop is identified as a next boundary loop vertex of the current vertex. A third vertex of the boundary loop is identified as a next boundary loop vertex of the second vertex of the boundary loop. A last vertex of the boundary loop is identified such that the current vertex is a next boundary loop vertex of the last vertex of the boundary loop.

Then, the process proceeds to (S699) and terminates.

The process (600) can be suitably adapted. Step(s) in the process (600) can be modified and/or omitted. Additional step(s) can be added. Any suitable order of implementation can be used.

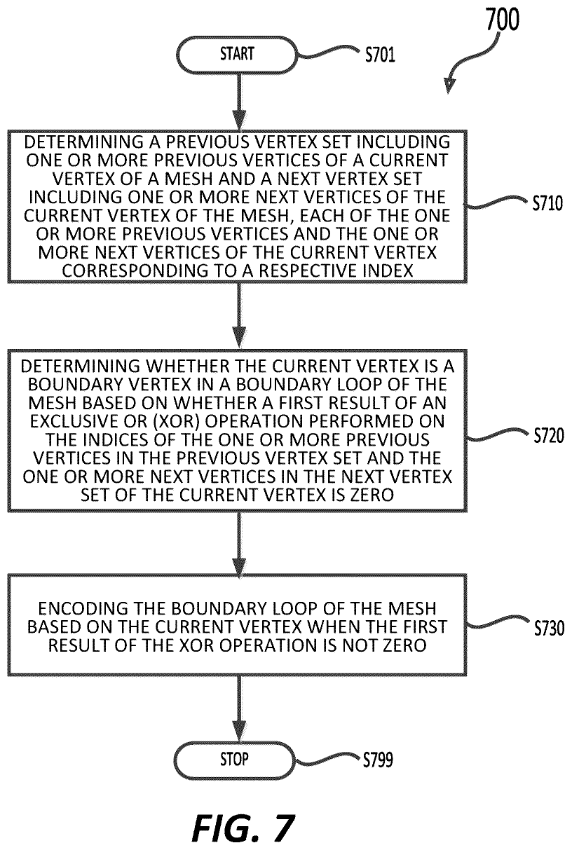

FIG. 7 shows a flow chart outlining a process (700) according to an aspect of the disclosure. The process (700) can be used in a video encoder. In various aspects, the process (700) is executed by processing circuitry, such as the processing circuitry that performs functions of the video encoder (103), the processing circuitry that performs functions of the video encoder (303), and the like. In some aspects, the process (700) is implemented in software instructions, thus when the processing circuitry executes the software instructions, the processing circuitry performs the process (700). The process starts at (S701) and proceeds to (S710).

At (S710), a previous vertex set including one or more previous vertices of a current vertex of a mesh and a next vertex set including one or more next vertices of the current vertex of the mesh are determined. Each of the one or more previous vertices and the one or more next vertices of the current vertex corresponds to a respective index.

At (S720), whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero.

At (S730), the boundary loop of the mesh is encoded based on the current vertex when the first result of the XOR operation is not zero.

In an aspect, when the current vertex is determined as the boundary vertex in the boundary loop of the mesh, a previous boundary loop vertex and a next boundary loop vertex of the current vertex in the boundary loop are identified. The boundary loop of the mesh is encoded based on (i) the current vertex and (ii) one of the previous boundary loop vertex and the next boundary loop vertex of the current vertex in the boundary loop.

In an aspect, the one or more previous vertices and the one or more next vertices of the current vertex are determined from one or more incident faces of the current vertex according to a predefined traversal direction. Each of the one or more incident faces of the current vertex includes at least one previous vertex and at least one next vertex of the current vertex.

In an aspect, the XOR operation is performed on the indices of the one or more previous vertices and the one or more next vertices of the current vertex to cancel duplicated vertices that have same indices. When the first result of the XOR operation is zero, the current vertex is determined as a non-boundary vertex. When the first result of the XOR operation is non-zero, the current vertex is determined as the boundary vertex in the boundary loop.

In an aspect, a non-zero first result indicates that at least two unique indices exist in the indices of the one or more previous vertices and the one or more next vertices of the current vertex. A significant bit is determined based on the first result of the XOR operation on the indices of the one or more previous vertices and the one or more next vertices of the current vertex. The one or more previous vertices and the one or more next vertices of the current vertex are divided into a first group of neighboring vertices with the significant bit and a second group of neighboring vertices without the significant bit. The XOR operation is performed on the first group of neighboring vertices of the current vertex to obtain a second result. The second result indicates a unique vertex in the first group of neighboring vertices. Whether the unique vertex is the next boundary loop vertex of the current vertex in the boundary loop is determined.

In an aspect, the XOR operation is performed on binary representations of the at least two unique indices to obtain a combined binary representation of the at least two unique indices. The significant bit is determined as one of a least significant bit and a most significant bit of the combined binary representation of the at least two unique indices.

In an aspect, when the unique vertex is included in the previous vertex set, the unique vertex is determined as the next boundary loop vertex of the current vertex in the boundary loop.

In an aspect, when the unique vertex is included in the next vertex set, the unique vertex is determined as the previous boundary loop vertex of the current vertex in the boundary loop.

In an aspect, the XOR operation is performed on the first result and the second result to identify a unique vertex in the first result and the second result as the previous boundary loop vertex of the current vertex in the boundary loop.

Then, the process proceeds to (S799) and terminates.

The process (700) can be suitably adapted. Step(s) in the process (700) can be modified and/or omitted. Additional step(s) can be added. Any suitable order of implementation can be used.

In an aspect, a method of processing video data (or visual media data) includes processing a bitstream of the video data according to a format rule. The video data includes mesh data. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a mesh with a plurality of vertices. The format rule specifies that a previous vertex set including one or more previous vertices of a current vertex of the mesh and a next vertex set including one or more next vertices of the current vertex of the mesh are determined. Each of the one or more previous vertices and the one or more next vertices of the current vertex corresponds to a respective index. The format rule specifies that whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero. The format rule specifies that the boundary loop of the mesh is processed based on the current vertex when the first result of the XOR operation is not zero.

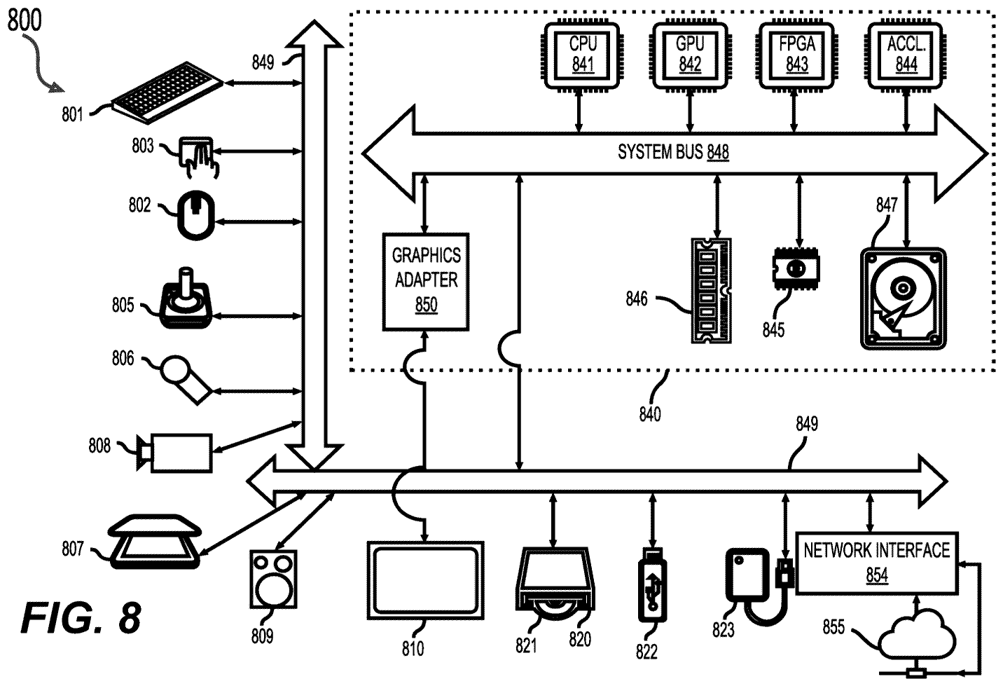

The techniques described above, can be implemented as computer software using computer-readable instructions and physically stored in one or more computer-readable media. For example, FIG. 8 shows a computer system (800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system (800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (800).

Computer system (800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (801), mouse (802), trackpad (803), touch screen (810), data-glove (not shown), joystick (805), microphone (806), scanner (807), camera (808).

Computer system (800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (810), data-glove (not shown), or joystick (805), but there can also be tactile feedback devices that do not serve as input devices), audio output devices (such as: speakers (809), headphones (not depicted)), visual output devices (such as screens (810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (800) can also include human accessible storage devices and their associated media such as optical media including CD/DVD ROM/RW (820) with CD/DVD or the like media (821), thumb-drive (822), removable hard drive or solid state drive (823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (800) can also include an interface (854) to one or more communication networks (855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (849) (such as, for example USB ports of the computer system (800)); others are commonly integrated into the core of the computer system (800) by attachment to a system bus as described below (for example Ethernet interface into a PC computer system or cellular network interface into a smartphone computer system). Using any of these networks, computer system (800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (840) of the computer system (800).

The core (840) can include one or more Central Processing Units (CPU) (841), Graphics Processing Units (GPU) (842), specialized programmable processing units in the form of Field Programmable Gate Areas (FPGA) (843), hardware accelerators for certain tasks (844), graphics adapters (850), and so forth. These devices, along with Read-only memory (ROM) (845), Random-access memory (846), internal mass storage such as internal non-user accessible hard drives, SSDs, and the like (847), may be connected through a system bus (848). In some computer systems, the system bus (848) can be accessible in the form of one or more physical plugs to enable extensions by additional CPUs, GPU, and the like. The peripheral devices can be attached either directly to the core's system bus (848), or through a peripheral bus (849). In an example, the screen (810) can be connected to the graphics adapter (850). Architectures for a peripheral bus include PCI, USB, and the like.

CPUs (841), GPUs (842), FPGAs (843), and accelerators (844) can execute certain instructions that, in combination, can make up the aforementioned computer code. That computer code can be stored in ROM (845) or RAM (846). Transitional data can also be stored in RAM (846), whereas permanent data can be stored for example, in the internal mass storage (847). Fast storage and retrieve to any of the memory devices can be enabled through the use of cache memory, that can be closely associated with one or more CPU (841), GPU (842), mass storage (847), ROM (845), RAM (846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (800), and specifically the core (840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (840) that are of non-transitory nature, such as core-internal mass storage (847) or ROM (845). The software implementing various aspects of the present disclosure can be stored in such devices and executed by core (840). A computer-readable medium can include one or more memory devices or chips, according to particular needs. The software can cause the core (840) and specifically the processors therein (including CPU, GPU, FPGA, and the like) to execute particular processes or particular parts of particular processes described herein, including defining data structures stored in RAM (846) and modifying such data structures according to the processes defined by the software. In addition or as an alternative, the computer system can provide functionality as a result of logic hardwired or otherwise embodied in a circuit (for example: accelerator (844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

(1) A method of mesh decoding, including: receiving a bitstream of a mesh that includes a plurality of vertices; determining a previous vertex set including one or more previous vertices of a current vertex of the mesh and a next vertex set including one or more next vertices of the current vertex of the mesh, each of the one or more previous vertices and the one or more next vertices of the current vertex corresponding to a respective index; determining whether the current vertex is a boundary vertex in a boundary loop of the mesh based on whether a first result of an exclusive or (XOR) operation performed on the indices of the one or more previous vertices in the previous vertex set and the one or more next vertices in the next vertex set of the current vertex is zero; and generating the boundary loop of the mesh based on the current vertex when the first result of the XOR operation is not zero.

(2) The method of feature (1), further including: when the current vertex is determined as the boundary vertex in the boundary loop of the mesh, identifying a previous boundary loop vertex and a next boundary loop vertex of the current vertex in the boundary loop; and generating the boundary loop of the mesh based on (i) the current vertex and (ii) one of the previous boundary loop vertex and the next boundary loop vertex of the current vertex in the boundary loop.

(3) The method of any of features (1) to (2), in which the determining the previous vertex set and the next vertex set further includes: determining the one or more previous vertices and the one or more next vertices of the current vertex from one or more incident faces of the current vertex according to a predefined traversal direction, each of the one or more incident faces of the current vertex including at least one previous vertex and at least one next vertex of the current vertex.

(4) The method of any of features (1) to (3), in which the determining whether the current vertex is the boundary vertex further includes: performing the XOR operation on the indices of the one or more previous vertices and the one or more next vertices of the current vertex to cancel duplicated vertices that have same indices; when the first result of the XOR operation is zero, determining the current vertex as a non-boundary vertex; and when the first result of the XOR operation is non-zero, determining the current vertex as the boundary vertex in the boundary loop.

(5) The method of feature (2), in which: a non-zero first result indicates that at least two unique indices exist in the indices of the one or more previous vertices and the one or more next vertices of the current vertex; and the identifying further includes: determining a significant bit based on the first result of the XOR operation on the indices of the one or more previous vertices and the one or more next vertices of the current vertex, dividing the one or more previous vertices and the one or more next vertices of the current vertex into a first group of neighboring vertices with the significant bit and a second group of neighboring vertices without the significant bit, performing the XOR operation on the first group of neighboring vertices of the current vertex to obtain a second result, the second result indicating a unique vertex in the first group of neighboring vertices, and determining whether the unique vertex is the next boundary loop vertex of the current vertex in the boundary loop.

(6) The method of feature (5), in which the determining the significant bit further includes: performing the XOR operation on binary representations of the at least two unique indices to obtain a combined binary representation of the at least two unique indices; and determining the significant bit as one of a least significant bit and a most significant bit of the combined binary representation of the at least two unique indices.

(7) The method of any of features (5) to (6), in which the determining whether the unique vertex is the next boundary loop vertex further includes: when the unique vertex is included in the previous vertex set, determining the unique vertex as the next boundary loop vertex of the current vertex in the boundary loop.

(8) The method of any of features (5) to (7), in which the determining whether the unique vertex is the next boundary loop vertex further includes: when the unique vertex is included in the next vertex set, determining the unique vertex as the previous boundary loop vertex of the current vertex in the boundary loop.

(9) The method of any of features (5) to (8), in which the identifying further includes: performing the XOR operation on the first result and the second result to identify a unique vertex in the first result and the second result as the previous boundary loop vertex of the current vertex in the boundary loop.

(10) The method of any of features (1) to (9), in which the generating the boundary loop of the mesh further includes: identifying a starting vertex of the boundary loop as the current vertex; identifying a second vertex of the boundary loop as a next boundary loop vertex of the current vertex; identifying a third vertex of the boundary loop as a next boundary loop vertex of the second vertex of the boundary loop; and identifying a last vertex of the boundary loop such that the current vertex is a next boundary loop vertex of the last vertex of the boundary loop.

(11) A method of mesh encoding, including: determining a previous vertex set including one or more previous vertices of a current vertex of a mesh and a next vertex set including one or more next vertices of the current vertex of the mesh, each of the one or more previous vertices and the one or more next vertices of the current vertex corresponding to a respective index; determining whether the current vertex is a boundary vertex in a boundary loop of the mesh based on whether a first result of an exclusive or (XOR) operation performed on the indices of the one or more previous vertices in the previous vertex set and the one or more next vertices in the next vertex set of the current vertex is zero; and encoding the boundary loop of the mesh based on the current vertex when the first result of the XOR operation is not zero.

(12) The method of feature (11), further including: when the current vertex is determined as the boundary vertex in the boundary loop of the mesh, identifying a previous boundary loop vertex and a next boundary loop vertex of the current vertex in the boundary loop; and encoding the boundary loop of the mesh based on (i) the current vertex and (ii) one of the previous boundary loop vertex and the next boundary loop vertex of the current vertex in the boundary loop.

(13) The method of any of features (11) to (12), in which the determining the previous vertex set and the next vertex set further includes: determining the one or more previous vertices and the one or more next vertices of the current vertex from one or more incident faces of the current vertex according to a predefined traversal direction, each of the one or more incident faces of the current vertex including at least one previous vertex and at least one next vertex of the current vertex.

(14) The method of any of features (11) to (13), in which the determining whether the current vertex is the boundary vertex further includes: performing the XOR operation on the indices of the one or more previous vertices and the one or more next vertices of the current vertex to cancel duplicated vertices that have same indices; when the first result of the XOR operation is zero, determining the current vertex as a non-boundary vertex; and when the first result of the XOR operation is non-zero, determining the current vertex as the boundary vertex in the boundary loop.

(15) The method of feature (12), in which: a non-zero first result indicates that at least two unique indices exist in the indices of the one or more previous vertices and the one or more next vertices of the current vertex; and the identifying further includes: determining a significant bit based on the first result of the XOR operation on the indices of the one or more previous vertices and the one or more next vertices of the current vertex, dividing the one or more previous vertices and the one or more next vertices of the current vertex into a first group of neighboring vertices with the significant bit and a second group of neighboring vertices without the significant bit, performing the XOR operation on the first group of neighboring vertices of the current vertex to obtain a second result, the second result indicating a unique vertex in the first group of neighboring vertices, and determining whether the unique vertex is the next boundary loop vertex of the current vertex in the boundary loop.

(16) The method of feature (15), in which the determining the significant bit further includes: performing the XOR operation on binary representations of the at least two unique indices to obtain a combined binary representation of the at least two unique indices; and determining the significant bit as one of a least significant bit and a most significant bit of the combined binary representation of the at least two unique indices.

(17) The method of any of features (15) to (16), in which the determining whether the unique vertex is the next boundary loop vertex includes: when the unique vertex is included in the previous vertex set, determining the unique vertex as the next boundary loop vertex of the current vertex in the boundary loop.

(18) The method of any of features (15) to (17), in which the determining whether the unique vertex is the next boundary loop vertex further includes: when the unique vertex is included in the next vertex set, determining the unique vertex as the previous boundary loop vertex of the current vertex in the boundary loop.

(19) The method of any of features (15) to (18), in which the identifying further includes: performing the XOR operation on the first result and the second result to identify a unique vertex in the first result and the second result as the previous boundary loop vertex of the current vertex in the boundary loop.

(20) A method of processing mesh data, the method including: processing a bitstream of the mesh data according to a format rule, in which: the bitstream include coded information of a mesh with a plurality of vertices; and the format rule specifies that: a previous vertex set including one or more previous vertices of a current vertex of the mesh and a next vertex set including one or more next vertices of the current vertex of the mesh are determined, each of the one or more previous vertices and the one or more next vertices of the current vertex corresponding to a respective index; whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero; and the boundary loop of the mesh is processed based on the current vertex when the first result of the XOR operation is not zero.

(21) An apparatus for mesh decoding, including processing circuitry that is configured to perform the method of any of features (1) to (10).

(22) An apparatus for mesh encoding, including processing circuitry that is configured to perform the method of any of features (11) to (19).

(23) A non-transitory computer-readable storage medium storing instructions which when executed by at least one processor cause the at least one processor to perform the method of any of features (1) to (19).

What is claimed is:

1. A method of mesh decoding, comprising:
receiving a bitstream of a mesh that includes a plurality of vertices;
determining a previous vertex set including one or more previous vertices of a current vertex of the mesh and a next vertex set including one or more next vertices of the current vertex of the mesh, each of the one or more previous vertices and the one or more next vertices of the current vertex corresponding to a respective index;
determining whether the current vertex is a boundary vertex in a boundary loop of the mesh based on whether a first result of an exclusive or (XOR) operation performed on the indices of the one or more previous vertices in the previous vertex set and the one or more next vertices in the next vertex set of the current vertex is zero; and
generating the boundary loop of the mesh based on the current vertex when the first result of the XOR operation is not zero.

2. The method of claim 1, further comprising:
when the current vertex is determined as the boundary vertex in the boundary loop of the mesh, identifying a previous boundary loop vertex and a next boundary loop vertex of the current vertex in the boundary loop; and
generating the boundary loop of the mesh based on (i) the current vertex and (ii) one of the previous boundary loop vertex and the next boundary loop vertex of the current vertex in the boundary loop.

3. The method of claim 1, wherein the determining the previous vertex set and the next vertex set further comprises:
determining the one or more previous vertices and the one or more next vertices of the current vertex from one or more incident faces of the current vertex according to a predefined traversal direction, each of the one or more incident faces of the current vertex including at least one previous vertex and at least one next vertex of the current vertex.

4. The method of claim 1, wherein the determining whether the current vertex is the boundary vertex further comprises:
performing the XOR operation on the indices of the one or more previous vertices and the one or more next vertices of the current vertex to cancel duplicated vertices that have same indices;
when the first result of the XOR operation is zero, determining the current vertex as a non-boundary vertex; and
when the first result of the XOR operation is non-zero, determining the current vertex as the boundary vertex in the boundary loop.

5. The method of claim 2, wherein:
a non-zero first result indicates that at least two unique indices exist in the indices of the one or more previous vertices and the one or more next vertices of the current vertex; and
the identifying further comprises:
determining a significant bit based on the first result of the XOR operation on the indices of the one or more previous vertices and the one or more next vertices of the current vertex,
dividing the one or more previous vertices and the one or more next vertices of the current vertex into a first group of neighboring vertices with the significant bit and a second group of neighboring vertices without the significant bit,
performing the XOR operation on the first group of neighboring vertices of the current vertex to obtain a second result, the second result indicating a unique vertex in the first group of neighboring vertices, and
determining whether the unique vertex is the next boundary loop vertex of the current vertex in the boundary loop.

6. The method of claim 5, wherein the determining the significant bit further comprises:
performing the XOR operation on binary representations of the at least two unique indices to obtain a combined binary representation of the at least two unique indices; and
determining the significant bit as one of a least significant bit and a most significant bit of the combined binary representation of the at least two unique indices.

7. The method of claim 5, wherein the determining whether the unique vertex is the next boundary loop vertex further comprises:
when the unique vertex is included in the previous vertex set, determining the unique vertex as the next boundary loop vertex of the current vertex in the boundary loop.

8. The method of claim 5, wherein the determining whether the unique vertex is the next boundary loop vertex further comprises:
when the unique vertex is included in the next vertex set, determining the unique vertex as the previous boundary loop vertex of the current vertex in the boundary loop.

9. The method of claim 5, wherein the identifying further comprises:
performing the XOR operation on the first result and the second result to identify a unique vertex in the first result and the second result as the previous boundary loop vertex of the current vertex in the boundary loop.

10. The method of claim 1, wherein the generating the boundary loop of the mesh further comprises:
identifying a starting vertex of the boundary loop as the current vertex;
identifying a second vertex of the boundary loop as a next boundary loop vertex of the current vertex;
identifying a third vertex of the boundary loop as a next boundary loop vertex of the second vertex of the boundary loop; and
identifying a last vertex of the boundary loop such that the current vertex is a next boundary loop vertex of the last vertex of the boundary loop.

11. A method of mesh encoding, comprising:
determining a previous vertex set including one or more previous vertices of a current vertex of a mesh and a next vertex set including one or more next vertices of the current vertex of the mesh, each of the one or more previous vertices and the one or more next vertices of the current vertex corresponding to a respective index;
determining whether the current vertex is a boundary vertex in a boundary loop of the mesh based on whether a first result of an exclusive or (XOR) operation performed on the indices of the one or more previous vertices in the previous vertex set and the one or more next vertices in the next vertex set of the current vertex is zero; and
encoding the boundary loop of the mesh based on the current vertex when the first result of the XOR operation is not zero.

12. The method of claim 11, further comprising:
when the current vertex is determined as the boundary vertex in the boundary loop of the mesh, identifying a previous boundary loop vertex and a next boundary loop vertex of the current vertex in the boundary loop; and
encoding the boundary loop of the mesh based on (i) the current vertex and (ii) one of the previous boundary loop vertex and the next boundary loop vertex of the current vertex in the boundary loop.

13. The method of claim 11, wherein the determining the previous vertex set and the next vertex set further comprises:
determining the one or more previous vertices and the one or more next vertices of the current vertex from one or more incident faces of the current vertex according to a predefined traversal direction, each of the one or more incident faces of the current vertex including at least one previous vertex and at least one next vertex of the current vertex.

14. The method of claim 11, wherein the determining whether the current vertex is the boundary vertex further comprises:
performing the XOR operation on the indices of the one or more previous vertices and the one or more next vertices of the current vertex to cancel duplicated vertices that have same indices;
when the first result of the XOR operation is zero, determining the current vertex as a non-boundary vertex; and
when the first result of the XOR operation is non-zero, determining the current vertex as the boundary vertex in the boundary loop.

15. The method of claim 12, wherein:
a non-zero first result indicates that at least two unique indices exist in the indices of the one or more previous vertices and the one or more next vertices of the current vertex; and
the identifying further comprises:
determining a significant bit based on the first result of the XOR operation on the indices of the one or more previous vertices and the one or more next vertices of the current vertex,
dividing the one or more previous vertices and the one or more next vertices of the current vertex into a first group of neighboring vertices with the significant bit and a second group of neighboring vertices without the significant bit,
performing the XOR operation on the first group of neighboring vertices of the current vertex to obtain a second result, the second result indicating a unique vertex in the first group of neighboring vertices, and
determining whether the unique vertex is the next boundary loop vertex of the current vertex in the boundary loop.

16. The method of claim 15, wherein the determining the significant bit further comprises:
performing the XOR operation on binary representations of the at least two unique indices to obtain a combined binary representation of the at least two unique indices; and
determining the significant bit as one of a least significant bit and a most significant bit of the combined binary representation of the at least two unique indices.

17. The method of claim 15, wherein the determining whether the unique vertex is the next boundary loop vertex further comprises:
when the unique vertex is included in the previous vertex set, determining the unique vertex as the next boundary loop vertex of the current vertex in the boundary loop.

18. The method of claim 15, wherein the determining whether the unique vertex is the next boundary loop vertex further comprises:
when the unique vertex is included in the next vertex set, determining the unique vertex as the previous boundary loop vertex of the current vertex in the boundary loop.

19. The method of claim 15, wherein the identifying further comprises:
performing the XOR operation on the first result and the second result to identify a unique vertex in the first result and the second result as the previous boundary loop vertex of the current vertex in the boundary loop.

20. A method of processing mesh data, the method comprising:
processing a bitstream of the mesh data according to a format rule, wherein:
the bitstream includes coded information of a mesh with a plurality of vertices; and
the format rule specifies that:
a previous vertex set including one or more previous vertices of a current vertex of the mesh and a next vertex set including one or more next vertices of the current vertex of the mesh are determined, each of the one or more previous vertices and the one or more next vertices of the current vertex corresponding to a respective index;
whether the current vertex is a boundary vertex in a boundary loop of the mesh is determined based on whether a first result of an exclusive or (XOR) operation performed on the indices of the one or more previous vertices in the previous vertex set and the one or more next vertices in the next vertex set of the current vertex is zero; and
the boundary loop of the mesh is processed based on the current vertex when the first result of the XOR operation is not zero.
